(19) United States
(12) Patent Application Publication
(10) Pub. No.: US 2022/0205814 A1
(43) Pub. Date: Jun. 30, 2022

(54) SENSING WINDING CONFIGURATION FOR INDUCTIVE POSITION ENCODER

(71) Applicant: Mitutoyo Corporation, Kanagawa-ken (JP)

(72) Inventor: Ted Staton Cook, Kirkland, WA (US)

(21) Appl. No.: 17/139,596

(22) Filed: Dec. 31, 2020

(51) Int. Cl. G01D 5/20; G01B 7/02; G01B 3/00; G01B 3/20

(52) U.S. Cl. CPC G01D 5/202; G01B 3/205; G01B 3/004; G01B 7/023

(57) ABSTRACT

An inductive type position encoder includes a scale, a detector portion and a signal processor. The scale includes a periodic pattern of signal modulating elements (SME) arranged along a measuring axis with a spatial wavelength W1. The SME in the pattern comprise similar conductive plates or loops. The detector portion comprises sensing elements and a field generating coil that generates a changing magnetic flux. The sensing elements may comprise conductive loop portions arranged along the measuring axis and configured to provide detector signals which respond to a local effect on the changing magnetic flux provided by adjacent SME's. In various implementations, SMEs having an average dimension DSME along the measuring axis direction that is at least 0.55*W1 and at most 0.8*W1 are combined with sensing elements having an average dimension along the measuring axis direction that is at least 0.285*W1 and at most 0.315*W1, which improves detector signal accuracy.

### BACKGROUND

### Technical Field

This disclosure relates to measurement instruments and, more particularly, to inductive position encoders that may be utilized in precision measurement instruments.

### Description of the Related Art

Various encoder configurations may include various types of optical, capacitive, magnetic, inductive, movement and/or position transducers. These transducers use various geometric configurations of a transmitter and a receiver in a read head to measure movement between the read head and a scale.

U.S. Pat. No. 6,011,389 (the '389 patent) and U.S. Pat. No. 6,124,708 (the '708 patent) describe induced current position transducers usable in high accuracy applications; U.S. Pat. No. 5,973,494 (the '494 patent) and U.S. Pat. No. 6,002,250 (the '250 patent) describe incremental position inductive calipers and linear scales, including signal generating and processing circuits; and U.S. Pat. No. 5,886,519 (the '519 patent), U.S. Pat. No. 5,841,274 (the '274 patent), and U.S. Pat. No. 5,894,678 (the '678 patent) describe absolute position inductive calipers and electronic tape measures using an induced current transducer. U.S. Pat. No. 10,520,335 (the '335 patent), U.S. Pat. No. 10,612,943 (the '943 patent) and U.S. Pat. No. 10,775,199 (the '199 patent) disclose winding configuration refinements that are useful for enhancing the accuracy, robustness, and ease of alignment of inductive position encoders. All of the foregoing are hereby incorporated herein by reference in their entireties. As described in these patents and applications, an induced current transducer may be manufactured using printed circuit board technology and is largely immune to contamination. However, such systems may be limited in their ability to provide certain combinations of features desired by users, such as combinations of compact size, high resolution, accuracy, low cost, robustness to contamination, etc. Configurations of encoders that provide improved combinations of such features would be desirable.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An electronic position encoder is provided that is usable to measure a relative position between two elements along a measuring axis direction. In various implementations, the electronic position encoder includes a scale, a detector portion and a signal processing configuration.

The scale extends along the measuring axis direction and includes a periodic scale pattern comprising at least a first type of signal modulating elements. The periodic scale pattern has a spatial wavelength W1. The signal modulating elements of the first type comprise similar conductive plates or similar conductive loops that are located along the measuring axis direction corresponding to the spatial wavelength W1. The detector portion is configured to be mounted proximate to the periodic scale pattern and to move along the measuring axis direction relative to the periodic scale pattern. In various implementations, the detector portion includes a field generating coil and a set of sensing elements. The field generating coil is fixed on a substrate and surrounds an interior area that is aligned with the periodic scale pattern of signal modulating elements during operation. As used herein, the term “surrounds” may mean completely surrounds, or partially surrounds, in various implementations. The only constraint is that the field generating coil is configured to generate a changing magnetic flux in the interior area in response to a coil drive signal, in a manner that supports operation according to the principles disclosed and claimed herein. The set of sensing elements is arranged along the measuring axis direction and fixed on the substrate. The members of the set of sensing elements comprise conductive loops or conductive loop portions that define a sensing element effective area EffASEN corresponding to that portion of their sensing element that is aligned with or overlaps the interior area surrounded by the field generating coil. The set of sensing elements are configured to provide detector signals which respond to a local effect on the changing magnetic flux that is provided by adjacent signal modulating elements of the scale pattern. The signal processing configuration is operably connected to the detector portion to provide the coil drive signal and to determine the relative position between the detector portion and the scale pattern based on detector signals input from the detector portion.

The signal modulating elements (SMEs) of the first type include an SME effective region EffRSME that is aligned with or overlaps the interior area during operation. In various implementations, the electronic position encoder is configured according to a combination of features wherein: the SME effective region EffRSME is configured to have an average dimension DSME along the measuring axis direction wherein DSME that is at least 0.55*W1 and at most 0.8*W1; and the sensing element effective area EffASEN that is aligned with or overlaps the interior area has an effective y-axis dimension EffYSEN along a y-axis direction that is perpendicular to the measuring axis direction, and a maximum dimension DSENmax along the measuring axis direction, and is configured to provide a sensing element average dimension DSENavg=(EffASEN/EffYSEN) along the measuring axis direction that is at least 0.285*W1 and at most 0.315*W1. Such a configuration provides advantageous detector signal characteristics (e.g., by providing better a signal to noise (S/N) ratio, and/or reduced error components, in the detector signals), according to principles disclosed herein.

In some implementations, the sensing element average dimension DSENavg is advantageously at least 0.29*W1 and at most 0.31*W1.

In some implementations, DSENmax may be least 0.285*W1 and at most 0.5*W1. In some such implementations, the conductive loops or conductive loop portions that define the effective area EffASEN comprise y-direction segments that are located at the maximum dimension DSENmax apart from one another and that extend straight along the y-axis direction and have a y-axis dimension YSEG that is at least 0.14*EffYSEN. In some such implementations, DSENmax is nominally 0.5*W1. In other such implementations, the y-direction segment dimension YSEG spans the entire interior area along the −y-axis direction and the y-direction segments are spaced apart from one another along the measuring axis direction at the maximum dimension DSENmax, wherein DSENavg=DSENmax, and DSENMax is at least 0.285*W1 and at most 0.315*W1.

In some implementations, the average dimension DSME is at least 0.6*W1, or 0.66*W1, or 0.7*W1 (e.g., the use of larger values of DSME may be advantageous when using larger operating gaps between the detector and the scale, and/or when the signal modulating elements of the first type comprise the similar conductive plates.)

In various implementations, the signal modulating elements of the first type may comprise similar conductive plates. In various implementations, the signal modulating elements of the first type may comprise similar conductive loops.

In various implementations, signal modulating elements of a second type are located between the signal modulating elements of the first type along the measuring axis direction. The signal modulating elements of a second type are configured to have relatively less effect on the changing magnetic flux in comparison to the signal modulating elements of the first type. In some implementations, the signal modulating elements of the second type comprise regions of non-conductive material. In some such implementations, the signal modulating elements of the second type comprise regions of a non-conductive scale substrate, wherein the first type of signal modulating elements are fixed on the non-conductive scale substrate.

In various implementations, the detector portion and the scale may include approximately planar substrates and the detector portion may be configured to be mounted approximately parallel to the periodic scale pattern with a nominal operating gap between their respective conductors which is at least 0.075*W1. In some such implementations, the nominal operating gap may be at least 0.15*W1.

In some implementations, the similar conductive plates or similar conductive loops of the signal modulating elements of the first type may comprise approximately parallel plate edges or approximately parallel conductive loop segments, respectively, that are oriented perpendicular to the measuring axis direction axis direction. Those parallel plate edges or parallel conductive loop segments bound the effective region of their associated signal modulating element. In such implementations, those parallel plate edges or parallel conductive loop segments are spaced at the average dimension DSME along the measuring axis direction.

In some implementations, W1 is at most 2 millimeters. In some implementations, W1 is at most 1.5 millimeters.

### BRIEF DESCRIPTION OF THE DRAWINGS

FIG. 1 is an exploded isometric view diagram of a hand tool type caliper utilizing an inductive electronic position encoder including a detector portion and a scale.

FIG. 2 is a plan view diagram schematically illustrating certain features of a representative prior art inductive electronic position encoder, presented as background information that is relevant to various principles disclosed herein.

FIG. 3 is a plan view diagram of an implementation of a detector portion and scale pattern usable in an electronic position encoder such as that shown in FIG. 1, wherein signal modulating elements according to principles disclosed herein are shown in combination with “less desirable” previously known sensing elements, along with various dimensions that may characterize their features according to principles disclosed herein.

FIG. 4 is an enlarged isometric view of a portion of the detector portion and scale pattern shown in FIG. 3, including a qualitative representation of a magnetic flux and flux coupling characteristics that may be associated with the operation of a signal modulating element in such a position encoder.

FIGS. 5A and 5B are plan view diagrams schematically illustrating certain aspects of respective signal modulating element and sensing element implementations analogous to those shown in FIG. 3, including additional examples of certain exemplary dimensions that may characterize their features according to principles disclosed herein.

FIG. 6 is a plan view diagram of illustrating certain aspects of a first exemplary implementation of sensing elements and signal modulating elements configured and combined according to principles disclosed herein for use a detector portion and scale pattern in an electronic position encoder such as that shown in FIG. 1, along with additional examples of various dimensions that may characterize their features according to principles disclosed herein.

FIG. 7 is a plan view diagram of illustrating certain aspects of a second exemplary implementation of sensing elements and signal modulating elements configured and combined according to principles disclosed herein for use a detector portion and scale pattern in an electronic position encoder, along with additional examples of various dimensions that may characterize their features according to principles disclosed herein.

FIG. 8 is a plan view diagram of illustrating certain aspects of a third exemplary implementation of sensing elements and signal modulating elements configured and combined according to principles disclosed herein for use a detector portion and scale pattern in an electronic position encoder, along with additional examples of various dimensions that may characterize their features according to principles disclosed herein.

### DETAILED DESCRIPTION

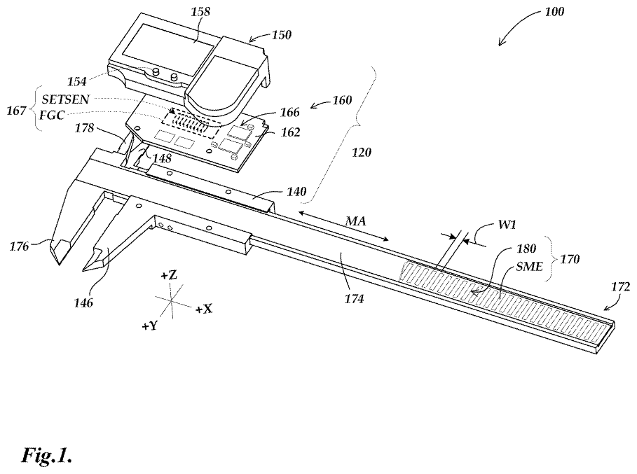

FIG. 1 is an exploded isometric view diagram of a hand tool type caliper 100 including a scale member 172 and slider assembly 120. The scale member 172 may comprise a spar of roughly rectangular cross-section including a scale 170 positioned in a groove therein. The slider assembly 120 may include a base 140, an electronic assembly 160, and a cover 150, described in greater detail below. The electronic assembly 160 may include a detector portion 167 and a signal processing configuration 166 arranged on a substrate 162. A resilient seal (not shown) may be compressed between the cover 150 and the substrate 162 to exclude contamination from the circuitry and connections. The scale 170, the detector portion 167 and the signal processing configuration 166 work cooperatively to provide an inductive electronic position encoder that is usable to measure a relative position between two elements (e.g., between the scale member 172 and slider assembly 120) along a measuring axis direction MA.

In various implementations, the scale 170 extends along the measuring axis direction MA (e.g., corresponding to an x-axis direction) and includes a signal modulating scale pattern 180, comprising signal modulating elements SME fabricated on a scale substrate (e.g., using known printed circuit fabrication methods). In various implementations illustrated herein, the signal modulating scale pattern 180 may alternatively be referred to as a periodic scale pattern 180, which is shown to have a spatial wavelength W1 in FIG. 1. In the illustrated implementation, a known type of cover layer 174 (e.g., 100 μm thick) covers the scale 170 (as shown by a cut away portion in FIG. 1.)

In various implementations, the mechanical structure and operation of the caliper 100 may be similar to that of certain prior electronic calipers, such as that of commonly assigned U.S. Pat. Nos. 5,901,458; and/or 6,400,138, and/or RE37490, each of which is hereby incorporated herein by reference in their entirety. Jaws 176 and 178 near a first end of the scale member 172 and movable jaws 146 and 148 on the slider assembly 120 are used to measure dimensions of objects in a known manner. The measured dimension may be displayed on a digital display 158, which is mounted within the cover 150 of the electronic assembly 160. The cover 150 may also include an on/off switch 154 and other optional control buttons if desired, which actuate circuits or elements included in the electronic assembly 160. The base 140 of the slider assembly 120 may include various known elements that are configured to guide it along a mating edge of the scale member 172 to ensure proper alignment for measuring, while moving the slider assembly 120 relative to the scale 170.

As shown in FIG. 1, the detector portion 167 may include a field generating coil FGC and a set of sensing elements SETSEN arranged along the measuring axis direction MA. In one specific illustrative example, the detector portion 167 may be arranged parallel with and facing the scale 170, and a front face of the detector portion 167 that faces the scale 170 may be separated from the scale 170 (and/or the scale pattern 180) by a gap on the order of 0.5 mm along the Z axis direction. The front face of the detector 167 (e.g., its constituent conductors) may be covered by an insulative coating. The structure and operation of the field generating coil FGC and the set of sensing elements SETSEN are described in greater detail below.

It will be appreciated that the caliper 100 shown in FIG. 1 is one of various applications that typically implement an electronic position encoder that has evolved over a number of years to provide a relatively optimized combination of compact size, low power operation (e.g., for long battery life), high resolution and high accuracy measurement, low cost, robustness to contamination, etc. For example, other applications that are perhaps even more challenging in terms of improving evolved accuracy, cost effective design and fabrication include medium and high accuracy digital “dial” indicators (e.g., providing accuracy on the order of 10 micrometers and 1 micrometer, respectively.) Even small improvements in any of these factors in any of these applications are highly desirable, but difficult to achieve, especially in light of the design constraints imposed in order to achieve commercial success in the various applications. The principles disclosed and claimed herein provide improvements in a number of these factors for various applications.

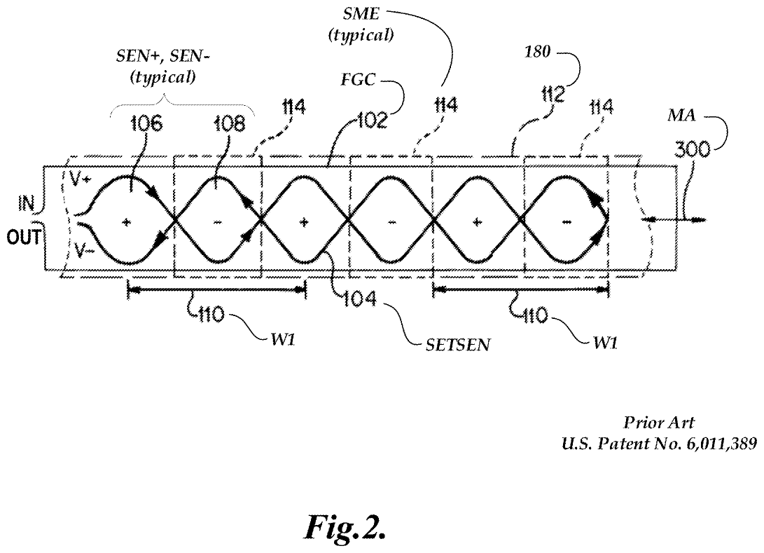

FIG. 2 is a plan view diagram schematically illustrating certain features of a representative prior art inductive electronic position encoder shown in the previously incorporated '389 patent, presented as background information that is relevant to various principles disclosed elsewhere herein. FIG. 2 furthermore includes reference numeral annotations to show the comparable reference numerals or symbols used to designate comparable elements in other figures included here. In the following abbreviated description, which is based on the disclosure of the '389 patent, the comparable reference numbers in other figures of the present disclosure are shown in parentheses following the original reference numerals from the '389 patent. A full description related to the prior art FIG. 2 may be found in the '382 patent. Therefore, only an abbreviated description including teachings from the '382 patent that are relevant to the present disclosure is included here. As far as the inventor has been able to ascertain, the teachings outlined below with reference to FIG. 2 represent the conventional reasoning and conventional design practice known in the art and/or used in commercial inductive electronic position encoders.

As disclosed in the '389 patent, a transducer such as that shown in FIG. 2 includes at least two substantially coplanar paths of wire or windings. A transmitter winding 102 (FGC) forms a large planar loop. A receiver winding 104 (SETSEN), in substantially the same plane as the transmitter winding 102, is laid out in one direction as indicated by the arrows in a zig-zag or sinusoidal pattern and then in a reverse direction as indicated by the arrows so that the winding crosses over itself to form alternating loops 106 (SEN+) and 108 (SEN−) interposed between each other, as shown. As a result, each of the alternating loops 106 (SEN+) and 108 (SEN−) of the receiver winding 104 (SETSEN) have a different winding direction as compared to adjacent loops. By applying an alternating (changing) current to the transmitter winding 102 (FGC), the transmitter winding produces a time-varying magnetic field, extending through the loops 106 (SEN+) and 108 (SEN−) of the receiver winding 104 (SETSEN).

If a scale or scale pattern 112 (180) (a segment of which is outlined by edges indicating alternating long-dash lines and short-dash lines in FIG. 2), including a conductive object (e.g., a conductive plate 114 (SME), several of which are outlined using short-dash lines on the scale pattern 112 in FIG. 2) is moved close to the transducer, the varying magnetic field generated by the transmitter winding 102 (FGC) will induce eddy currents in the conductive object, which in turn sets up a magnetic field from the object that counteracts the varying transmitter magnetic field. As a result, the magnetic flux that the receiver winding 104 (SETSEN) receives is altered or disrupted, thereby causing the receiver winding to output a non-zero EMF signal (a voltage) at the output terminals V+ and V− of the receiver winding 104, which will change polarity as the conductive object moves between the “+” and“−” loops 106 (SEN+) and 108 (SEN−).

The distance between the location of two loops of the same polarity, (e.g., between the location of a loop 106 (SEN+) to the location of the next loop 106 (SEN+)) is defined as a pitch or wavelength 110 (W1) of the transducer. It may be seen that each loop 106 (SEN+) and/or 108 (SEN−) therefore has a length or maximum dimension 0.5*W1 along the measuring axis direction 300. If the conductive object described above (e.g., a conductive plate 114 (SME)) is proximate to the receiver winding 104 (SETSEN) and is continuously varied in position along a measuring axis 300 (MA), the AC amplitude of the signal output from the receiver winding (SETSEN) will vary continuously and periodically with the wavelength 110 (W1) due to the periodic alteration of the loops 106 (SEN) and 108 (SEN) and local disruption of the transmitted magnetic field caused by the conductive object (e.g., a conductive plate 114 (SME)).

The '389 patent emphasizes that if the conductive object (e.g., a conductive plate 114 (SME)) is much smaller or larger than the loops 106 and/or 108 (SEN+, SEN−), then the amplitude of the signal output will be weak and high accuracy will be difficult to obtain. The signal output will have a large amplitude and, thus, be most sensitive to position of the conductive object (e.g., a conductive plate 114 (SME)) if it has a length equal to about half the wavelength 110 (W1) (i.e., when it is possible for the object to be positioned coincident with the loops 106 or 108 (SEN+ or SEN−) exactly). Consequently, the present invention (of the '389 patent) preferably employs conductive objects (e.g., conductive plates 114 (SME)) that have a length (along the x-axis direction) equal to one half the wavelength 110 (W1).

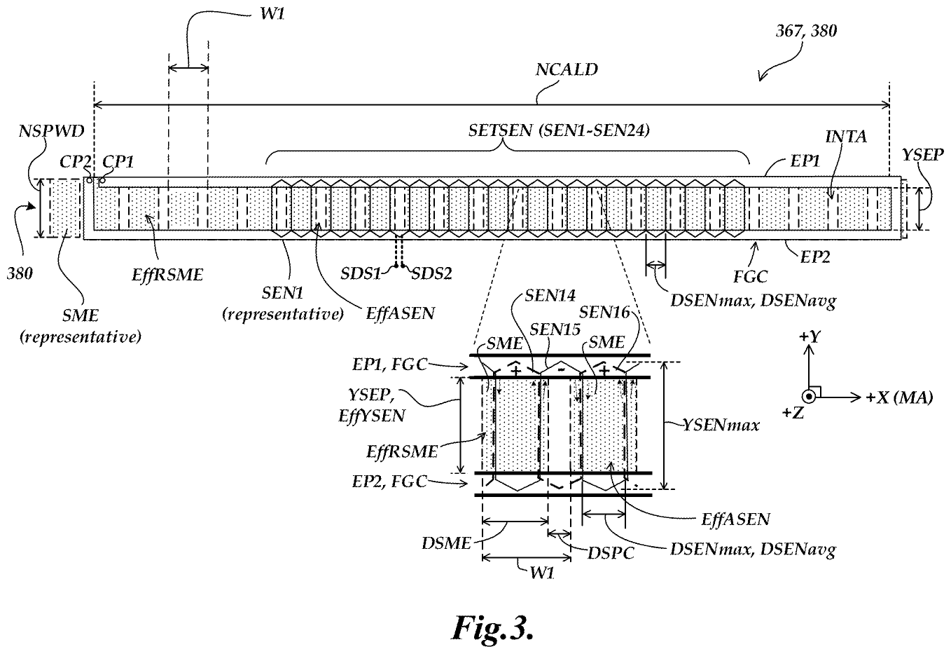

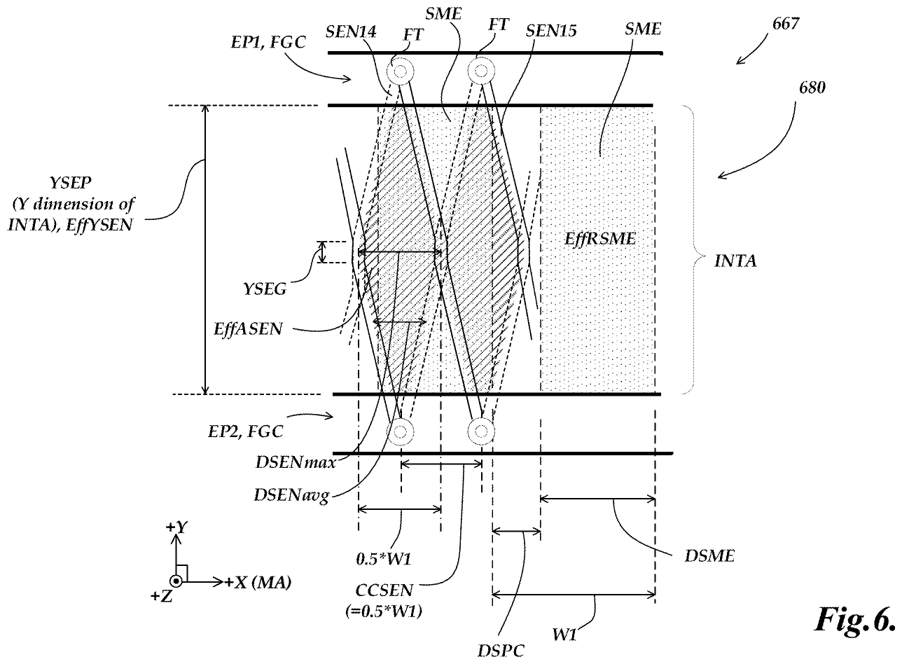

It will be appreciated that the transmitter winding 102 (FGC) and the receiver winding 104 (SETSEN) shown in FIG. 2 and described above are one example of a prior art implementation of elements that are designated as a detector portion herein (e.g., the detector portion 167 shown in FIG. 1.) The scale or scale pattern 112 (180) is one example of a prior art implementation that is designated as a scale pattern herein (e.g., the scale pattern 180 shown in FIG. 1.) FIG. 3 is a plan view diagram of an implementation of a detector portion 367 and scale pattern 380 usable in an electronic position encoder such as that shown in FIG. 1, wherein signal modulating elements SME according to principles disclosed herein are shown in combination with previously known “less desirable” sensing elements SEN, for clarity of description. FIG. 3 also introduces various dimensions that may characterize features of the signal modulating elements SME and sensing elements SEN according to principles disclosed herein. More desirable sensing elements SEN according to principles disclosed herein are described further below with reference to FIGS. 6, 7 and 8.

Various features of the detector portion 367 and scale pattern 380, are configured to fulfill various design principles disclosed and claimed herein, particularly with regard to the signal modulating elements SME. It will be appreciated that certain numbered components 3XX of FIG. 3 may correspond to and/or provide similar operations or functions as similarly numbered components 1XX of FIG. 1 and/or FIG. 2 (e.g., detector portion 367 provides similar operations or functions to detector portion 167), and may be similarly understood unless otherwise indicated.

FIG. 3 may be regarded as partly representational, partly schematic. An enlarged section of the detector portion 367 and scale pattern 380 is illustrated in the lower portion of FIG. 3. In FIG. 3, the various elements described below are represented by their shape or outline, and are shown superimposed on one another to emphasize certain geometric relationships. It should be understood that various elements may reside on different fabrication layers located at different planes along the z-axis direction, as needed to provide various operating gaps and/or insulating layers, as will be apparent to one of ordinary skill in the art based on the following description and the incorporated references. Throughout the figures of this disclosure, it will be appreciated that the illustrated x-axis, y-axis and/or z-axis dimensions of one or more elements may be exaggerated for clarity, but it will be understood that they are not intended to contradict the various dimensional design principles and relationships disclosed and claimed herein.

The illustrated portion of the scale pattern 380 includes a first type of signal modulating elements SME shown in dashed outline with a dotted fill. The periodic scale pattern 380 has a spatial wavelength W1. In this implementation, the signal modulating elements SME of the first type comprise similar conductive plates (e.g., as formed by regions fabricated on a printed circuit board, or as formed by raised regions extending from a conductive substrate). However, in other implementations they may comprise similar conductive loops (e.g., as formed by traces on a printed circuit board), as described in greater detail below. In either case, they are located along the measuring axis direction MA corresponding to the spatial wavelength W1. The scale pattern 380 is generally implemented on a scale (e.g., the scale 170 shown in FIG. 1). The y-direction extremes of most of the signal modulating elements SME are hidden below the first and second elongated portions EP1 and EP2 of the field generating coil FGC in the implementation illustrated in FIG. 3 (e.g., as described in the '335, '943, and '199 patents.) It will be appreciated that the scale pattern 380 moves relative to the detector portion 367 during operation, as may be seen in FIG. 1.

In the example of FIG. 3, the scale pattern 380 has a nominal scale pattern width dimension NSPWD along the y-axis direction and comprises generally rectangular signal modulating elements SME that are arranged periodically along the measuring axis direction MA (e.g., corresponding to the x-axis direction). However, more generally the scale pattern 380 may comprise various alternative spatially modulated patterns including alternative signal modulating element configurations, provided that the pattern has a spatial characteristic which changes as a function of position along the x-axis direction, so as to provide position dependent detector signals (also referred to as detector signal components, in some implementations) arising in the sensing elements SEN (e.g., SEN14) of the set of sensing elements SETSEN in the detector portion 367.

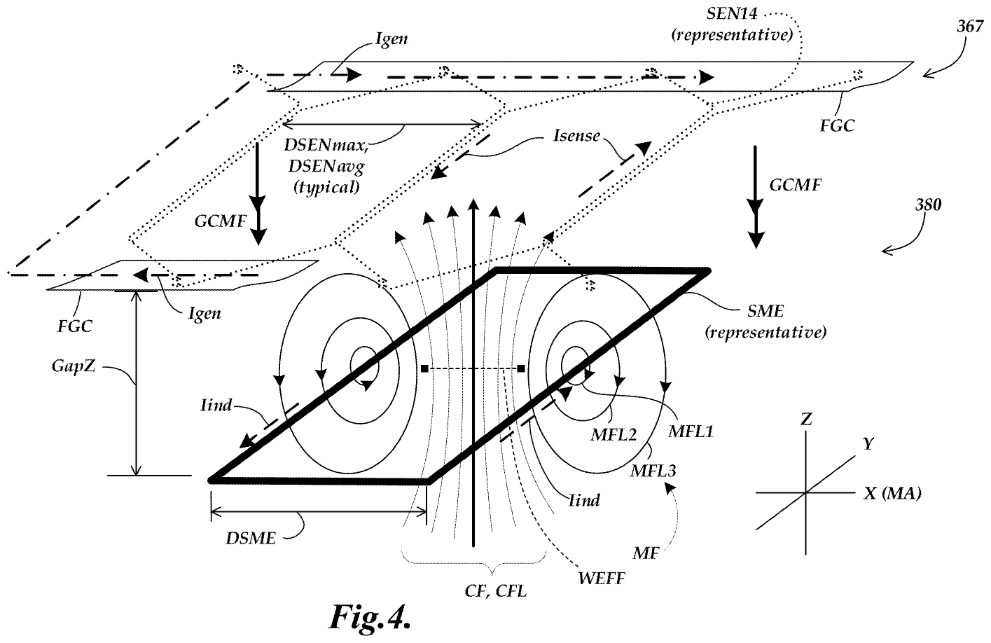

In various implementations, the detector portion 367 is configured to be mounted proximate to the scale pattern 380, and to move along the measuring axis direction MA relative to the scale pattern 380. The detector portion includes a field generating coil FGC and a set of sensing elements SETSEN, which may take a variety of alternative configurations to be used in combination with a variety of corresponding signal processing schemes in various implementations, as will be understood by one skilled in the art. FIG. 3 shows a single representative set of sensing elements SEN1-SEN24, which in this implementation comprise sensing loop elements (alternatively referred to as sensing coil elements or sensing winding elements) which are connected in series. In this implementation, adjacent loop elements are connected by a configuration of conductors on various layers of PCB (e.g., connected by feedthroughs) according to known methods (e.g., as illustrated in FIG. 4) such that they have opposite winding polarities. That is, if a first loop responds to a changing magnetic field with a positive polarity detector signal contribution, then the adjacent loops respond with a negative polarity detector signal contribution. Loops having a positive polarity detector signal contribution may be designated SEN+ sensing elements herein, and loops having a negative polarity detector signal contribution may be designated SEN− sensing elements in various contexts herein. In this implementation, the sensing elements are connected in series such that their detector signals or signal contributions are summed, and a “summed” detector signal is output at the detector signal output connections SDS1 and SDS2 to a signal processing configuration (not shown).

Although FIG. 3 shows a single set of sensing elements to avoid visual confusion, it will be appreciated that in various implementations it is advantageous to configure the detector to provide one or more additional sets of sensing elements (e.g., similar to SETSEN) at a different spatial phase position (e.g., to provide quadrature signals), as will be understood by one of ordinary skill in the art. However, it should be appreciated that the configurations of sensing elements described herein are exemplary only, and not limiting. As one example, individual sensing element loops may output individual signals to a corresponding signal processing configuration in some implementations, for example as disclosed in U.S. Pat. No. 9,958,294, which is hereby incorporated by reference in its entirety. More generally, various known sensing element configurations may be used in combination with the principles disclosed and claimed herein, for use in combination with various known scale pattern and signal processing schemes, in various implementations.

The various members of the set of sensing elements SETSEN and the field generating coil FGC may be fixed on a substrate (e.g., substrate 162 of FIG. 1). The field generating coil FGC may be described as surrounding an interior area INTA having a nominal coil area length dimension NCALD along the x-axis direction and a nominal coil area width dimension of approximately YSEP along the y-axis direction. The interior area INTA is aligned with the periodic scale pattern 380 of signal modulating elements SME during operation, approximately as illustrated. In the illustrated implementation, the field generating coil FGC comprises a single turn surrounding the interior area INTA. However, it will be understood that in various other implementations, the field generating coil FGC may comprise a plurality of turns, and/or meander to operationally surround (e.g., operationally partially surround) the interior area INTA that is aligned with the scale pattern 380, as well as to operationally surround (e.g., operationally partially surround) other interior areas aligned with scale tracks that include other scale patterns, as disclosed in the incorporated references. In any case, in operation the field generating coil FGC generates a changing magnetic flux in the interior area INTA in response to a coil drive signal. In the illustrated implementation, the first and second connection portions CP1 and CP2 may be used to connect a coil drive signal from a signal processing configuration (e.g., the signal processing configuration 166 of FIG. 1) to the field generating coil FGC.

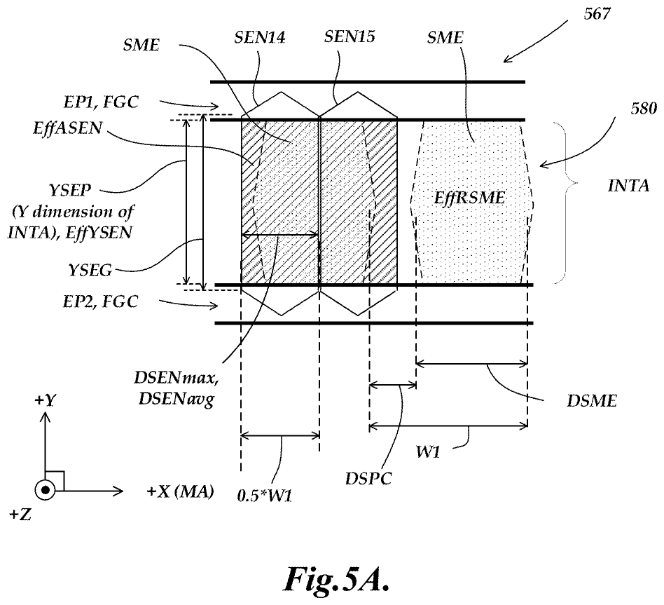

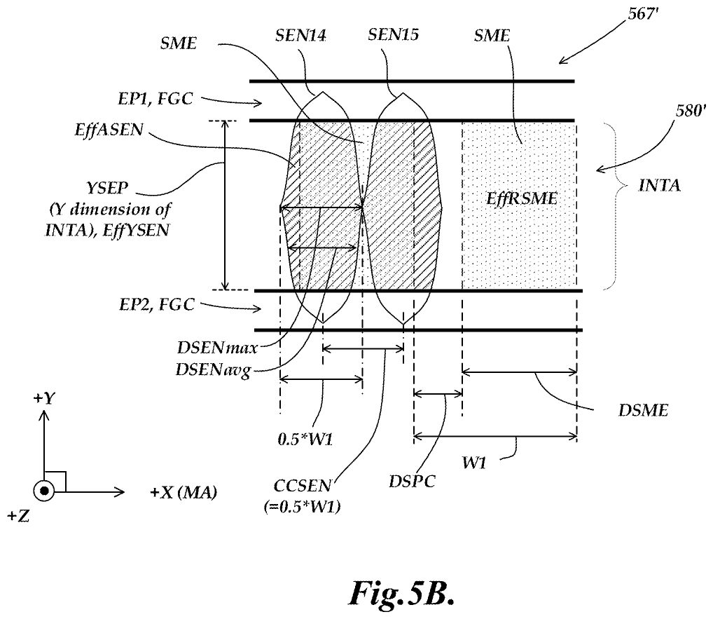

The set of sensing elements SETSEN (e.g., the sensing elements SEN1-SEN24) are arranged along the x-axis direction (e.g., corresponding to the measuring axis direction MA) and are fixed on the substrate (e.g., substrate 162 of FIG. 1). As shown in FIG. 3, the members of the set of sensing elements comprise conductive loops or conductive loop portions (e.g., SEN1-SEN24) that define a sensing element effective area EffASEN corresponding to that portion of their sensing element that is aligned with or overlaps the interior area INTA surrounded by the field generating coil FGC (that is, that portion of the sensing element that is aligned with or overlaps the dimension YSEP of INTA.) In various implementations, the sensing element effective area EffASEN that is aligned with or overlaps the interior area INTA may be described as having an effective y-axis dimension EffYSEN along a y-axis direction that is perpendicular to the measuring axis direction, and a maximum dimension DSENmax along the measuring axis direction (the x-axis direction). In the particular implementation shown in FIG. 3, the effective y-axis dimension EffYSEN is equal to YSEP, because each of the sensing elements SEN has a maximum sensing element dimension YSENMAX along the y-axis direction that exceeds YSEP and its effective area EffASEN therefore extends over the entire dimension YSEP. The maximum dimension DSENmax along the measuring axis direction is nominally 0.5*W1. However, these characteristics are specific to this implementation and are not limiting, and may be optional (or undesirable) in various implementations, as described in greater detail below with reference to FIGS. 5B, 6, 7, and 8.

It is useful to further characterize the sensing element effective area EffASEN by its sensing element average dimension DSENavg=(EffASEN/EffYSEN) along the measuring axis direction. For the particular implementation shown in FIG. 3, DSENavg is the same as DSENmax because the element effective area EffASEN has parallel sides that are perpendicular to the x-axis direction. However, this need not be the case in all implementations, as described in greater detail below with reference to FIGS. 5B, 6, 7, and 8.

The members of the set of sensing elements SETSEN are configured to provide detector signals which respond to a local effect on the changing magnetic flux provided by an adjacent signal modulating elements SME of the scale pattern 380 (e.g., one or more signal modulating elements SME). A signal processing configuration (e.g., the signal processing configuration 166 of FIG. 1, etc.) may be configured to determine a position of the set of sensing elements SETSEN relative to the scale pattern 380 based on the detector signals input from the detector portion 367. In general, the field generating coil FGC and the set of sensing elements SETSEN, or the like, may operate according to known principles (e.g., for inductive encoders), such as those described in the incorporated references.

In various implementations, the field generating coil FGC and the sensing elements SEN are insulated from one another (e.g., as located in different layers of a printed circuit board, etc.). In one such implementation, the maximum sensing element y-axis dimension YSENmax of the sensing elements SEN is advantageously greater than the nominal coil area width dimension YSEP and extends beyond the interior edges of the elongated portions EP1 or EP2 by an amount defined as an overlap dimension. In addition, the field generating coil FGC may be advantageously configured such that the trace width of the elongated portions EP1 and EP2 along the y-axis direction is larger than the corresponding overlap dimension. In various implementations, the elongated portions EP1 and EP2 may be fabricated on a first layer of a printed circuit board, and the sensing elements SEN may comprise conductive loops fabricated in one or more layers of the printed circuit board that include a layer different than the first layer, at least in the vicinity of the overlap dimension. However, such implementations are exemplary only and not limiting, as described further below.

As previously indicated, in some implementations the field generating coil FGC may comprise a conductive trace or traces fabricated on the printed circuit board, and the members SEN of the set sensing elements SETSEN may comprise magnetic flux sensing loops or loop portions formed by conductive traces fabricated on the printed circuit board. As described above with respect to FIG. 1, in various implementations the detector portion 367 may be included in various types of measurement instruments (e.g., calipers, micrometers, gauges, linear scales, etc.). For example, the detector portion 367 may be fixed to a slide member, and the scale pattern 380 may be fixed to a beam or spar member having a measuring axis that coincides with an x-axis direction. In such a configuration, the slide member may be movably mounted on the beam or spar member and movable along the measuring axis direction MA in a plane that extends along the x-axis direction and a y-axis direction, with a z-axis direction being orthogonal to the plane.

Regarding the enlarged section of the detector portion 367 and scale pattern 380 illustrated in the lower portion of FIG. 3, it shows three exemplary members SEN14, SEN15 and SEN16 of the set sensing elements SETSEN and two exemplary signal modulating elements SME, bordered by portions of the field generating coil FGC. In this implementation, the sensing elements may be formed by traces fabricated on first and second layers of a circuit board with a layer of insulator therebetween. The “first layer” traces are shown as solid lines, and the “second layer” traces are shown as dashed lines. Small arrows show a direction of current flow induced in the traces by a changing magnetic field arising from the field generating coil FGC. It may be seen that the sensing element SEN14 may be characterized as a “SEN+” polarity loop due to its associated current direction, and the adjacent sensing element SEN15 may be characterized as “SEN-” polarity loop due to its associated “opposite polarity” current direction. The next adjacent sensing element SEN16 may again be characterized as a “SEN+” polarity loop, and so on.

DSME is the average dimension along the measuring axis direction MA of the “effective region” EffRSME of a signal modulating elements SME (of the first type). The effective region EffRSME of a signal modulating element SME is defined here as that portion which is aligned with or overlaps the y-axis dimension of the interior area INTA. The effective region EffRSME produces the primary signal modulation effect in the sensing elements SEN. For the example shown in FIG. 3, it may be seen that this is the portion of the signal modulating element SME that coincides with the span of the dimension YSEP along the y-axis direction for the implementation shown in FIG. 3. In various implementations, the average dimension DSME of a signal modulating element SME may be taken as the area of the effective region EffRSME of a signal modulating element SME divided by the y-axis direction dimension of the effective region EffRSME. Additional examples of the dimension DSME for other configurations of signal modulating elements SME are shown in FIGS. 5A, 5B, 6, 7 and 8.

As previously outlined with reference to FIG. 2, it has been conventional for sensing elements, such as the sensing elements SEN, to have a maximum dimension DSENmax along the measuring axis direction that is 0.5*W1. Such a dimension may be advantageous in various implementations. Furthermore, as previously outlined with reference to FIG. 2, it has also been conventional for signal modulation elements such as the signal modulation elements SME to have an average width dimension DSME that is 0.5*W1. Contrary to the convention prior art design practice outlined immediately above, the inventor has discovered that certain performance characteristics may be improved when the signal modulation elements SME are configured to have an average width dimension DSME that is significantly larger than 0.5*W1, as illustrated in FIG. 3. For example, in various implementations it may be advantageous if DSME is at least 0.55*W1 and at most 0.8*W1. In some such implementations, it may be most advantageous if DMSE is at least 0.66*W1, or 0.7*W1, or more. Some reasons for this are described below with reference to FIG. 4.

In addition, the inventor has furthermore found that in order to mitigate certain errors that would otherwise appear, for the best accuracy in various applications it is most desirable to use them in combination with unconventional sensing elements SEN configured such that their sensing element average dimension DSENavg falls in a range that is significantly less than 0.5*W1. For example, in various implementations it may be desirable if the sensing element average dimension DSENavg is at least 0.285*W1 and at most 0.315*W1, This aspect of the invention is described in greater detail below with reference to FIGS. 6, 7 and 8. The unconventional combination of characteristics outlined above provides advantageous detector signal characteristics (e.g., providing better a signal to noise (S/N) ratio, and or reduced error components in the detector signals), in comparison to configurations according to prior art design principles.

FIG. 4 is an enlarged isometric view of a portion of the detector portion 367 and scale pattern 380 shown in FIG. 3, including a qualitative representation of a magnetic flux and flux coupling characteristics that may be associated with the operation of a signal modulating element SME in such a position encoder. FIG. 4 shows various considerations related to why signal modulation elements SME may be advantageously configured to have an average width dimension DSME that is at least 0.55*W1 and at most 0.8*W1 in various implementations.

FIG. 4 shows the response of a signal modulating element SME to a generated changing magnetic field GCMF provided by the field generating coil FGC as outlined previously. As shown in FIG. 4, an applied coil drive signal current Igen in the field generating coil FGC generates the changing magnetic field GCMF, which inductively couples to the signal modulating element SME. The signal modulating element SME is schematically illustrated as a conductive loop in FIG. 4. In response to the coupled changing magnetic field GCMF, an induced current Iind is produced in the signal modulating element SME, which generates an induced magnetic field represented by flux lines (the flux lines including arrow heads in FIG. 4). The illustrated flux lines represent a central magnetic flux CF represented by the central magnetic flux lines CFL, and a marginal magnetic flux MF represented by the closed marginal magnetic flux lines MFL1-MFL3, which are shown encircling the conductive loop of the signal modulating element SME.

Generally speaking, it will be understood that the members of the set of sensing elements SETSEN produce signals (or signal contributions) that are responsive to the induced changing magnetic flux that is represented as outlined above. In particular, the produced signals are responsive to the amount of magnetic flux that is effectively coupled through their interior loop area, to produce a signal contribution or signal component, which is represented as a current Isense in the sensing element SEN14 in FIG. 4. As shown in FIG. 4, in various implementations, the detector portion 367 and the scale pattern 380 may be approximately planar (e.g., they may include or be formed on approximately planar substrates) and the detector portion 367 may be configured to be mounted approximately parallel to the periodic scale pattern 380 with a nominal operating gap GapZ between their respective conductors. For example, in various implementations the nominal operating GapZ may be at least 0.075*W1, to facilitate practical assembly and alignment tolerances. In some such implementations, the nominal operating gap may be at least 0.15*W1. As shown in FIG. 4, the central magnetic flux CF will generally be effectively coupled through the sensing element SEN14 over a practical range of operating gaps. However, due to the operating gap at least some of the marginal magnetic flux MF may not be effectively coupled through the sensing element SEN14. For example, at a relatively larger dimension for the operating gap GapZ, as exaggerated in FIG. 4, none of the marginal magnetic flux lines MFL1-MFL3 are coupled through the sensing element SEN14, and do not contribute to the current Isense. As a result, for the configuration qualitatively illustrated in FIG. 4, the effective width Weff (represented by a dashed bar line in FIG. 4) of the signal modulating element SME that is sensed by the sensing element SEN14 corresponds only to the coupled central magnetic flux lines CFL. It may be seen in FIG. 4, that even as the operational gap GapZ is reduced, for example to couple the marginal magnetic flux line MFL3 through the sensing element SEN14, the effective width Weff would still be less than the average dimension DSME of the signal modulating element SME.

Thus, contrary to conventional prior art teachings outlined above with reference to FIG. 2, a signal modulating element SME advantageously has an average dimension DSME that is greater than the desired effective width Weff, in order to have an effective width Weff that produces the desired maximum signal variation and/or desired signal profile vs. displacement as it is moved past the sensing elements SEN along the measuring axis direction. For example, in some implementations it may be desirable for the dimension Weff to be approximately 0.5*W1, which according to the foregoing discussion means that when using a practical operational gap GapZ the average dimension DSME of a signal modulating element SME may desirably be at least 0.6*W1, or, 0.66*W1, or 0.7*W1, or more in some such implementations.

It should be appreciated that when the signal modulating elements SME are conductive plates, rather than conductive loops as shown in FIG. 4, a distribution of “concentric” eddy currents may be produced in such conductive plates in response to the generated changing magnetic field GCMF. These eddy currents are operationally comparable to the induced current Iind shown in FIG. 4. However, if the conductive plate has an average dimension DSME that is the same as the conductive loop SME shown in FIG. 4, then due to their distributed “concentric” pattern of its eddy currents, their “equivalent current location” will be somewhere inside the edges of the conductive plate, resulting an even smaller effective width Weff that than associated with a conductive loop of similar size. Consequently, in addition to using a relatively larger value of the average dimension DSME when using a relatively larger operating gap between the detector portion 367 and the scale pattern 380, it may be especially desirable for a conductive plate type signal modulating element SME to have an average dimension DSME that is toward the larger end of the desirable ranges outlined above. For example, the inventor has found average dimension DSME between 0.7*W1 and 0.8*W1 to be advantageous in some such implementations.

As a further consideration, regarding the desired signal profile vs. displacement it should be appreciated that the undesirable spatial harmonics included in the signal profile generally speaking depends on the shape of the signal modulating elements SME and their effective width Weff and the shape and width of the sensing elements SEN, as well as the operating gap between them. For example, in detector and scale configurations analogous to those outlined above, when the effective width Weff is approximately 0.5*W1, the even numbered spatial harmonics are largely eliminated from the detector signals. However, the odd spatial harmonics corresponding to 0.33*W1, and so on, may remain. It has been suggested in U.S. patent application Ser. No. 16/021,528, published as US 2020/0003581, that configuring the signal modulating element SME to provide an effective width Weff of 0.66*W1 may tend to suppress the odd spatial harmonics corresponding to 0.33*W1. Alternatively, the inventor has recently learned that it has been suggested in the previously incorporated '708 patent that configuring the signal modulating elements with an actual width of ⅚*W1 (approximately 0.83*W1) with or without a slot of width ⅙*W1 in their middle may tend to suppress the odd spatial harmonics corresponding to 0.33*W1. It is noted that this fails to take into account the explanation of effective width Weff outlined above, and therefore not likely to operate as described in the '708 patent. In any case, these configurations have not provided the expected or desired level of spatial filtering, in practice. Due to the high accuracies already achieved by previously known state-of-the-art inductive position encoders, these configurations have not provided spatial filtering at a level at the expected or predicted level, and have not desirably improved upon or advanced the state of the art in this regard.

As disclosed herein, the inventor has discovered certain configurations of the sensing elements SEN that may be used in combination with configurations of the signal modulating element SME outlined above to remedy the spatial filtering shortcomings outlined above. Various desirable configurations for the sensing elements SEN are described in detail below with reference to FIGS. 6, 7, and 8. However, prior to that, the definition or interpretation of certain dimensions and terms used in that description are clarified with reference to examples shown FIGS. 5A and 5B. FIGS. 5A and 5B are plan view diagrams schematically illustrating certain aspects of respective signal modulating element and sensing element implementations analogous to those shown in FIG. 3, including additional examples of certain exemplary dimensions that may characterize their features according to principles disclosed herein.

FIGS. 5A and 5B are plan view diagrams schematically illustrating respective inductive electronic position encoder implementations, illustrating further examples of the dimensions and terms DSENmax, DSENavg, DSME, EffRSME, EffASEN, and EffYSEN previously outlined with reference to FIG. 3. The dimension YSEG is also introduced and explained. It will be appreciated that certain numbered components 5XX of FIGS. 5A and 5B may correspond to and/or provide similar operations or functions as similarly numbered components 3XX of FIG. 3, and may be similarly understood unless otherwise indicated.

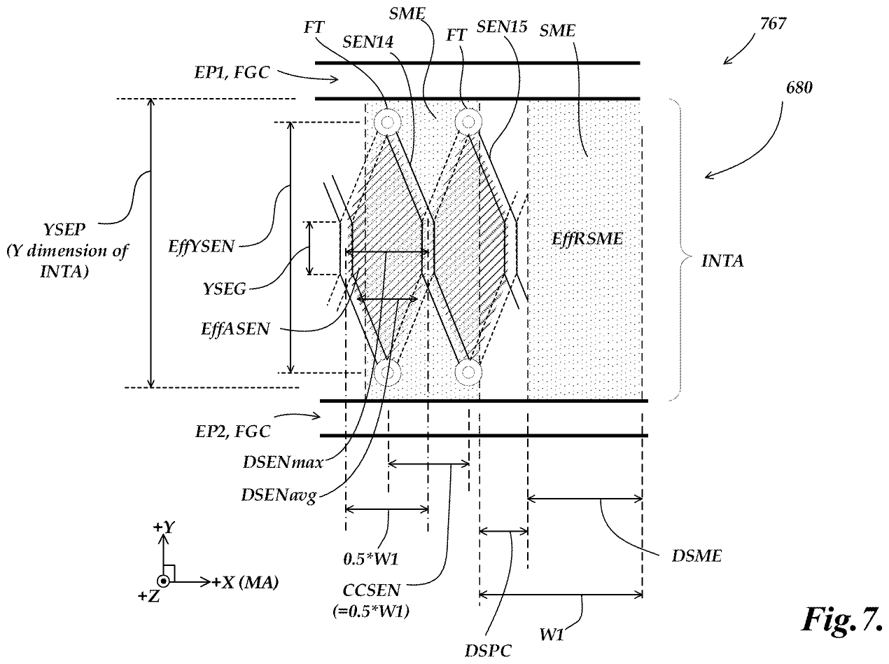

FIGS. 5A and 5B show the spatial wavelength W1 and the previously outlined dimensions and terms as applied to a non-straight boundary profile for the signal modulating elements SME in FIG. 5A, and for a non-straight boundary profile for a sensing element in FIG. 5B. The previously outlined effective region EffRSME of the signal modulating elements SME is indicated by a dotted fill within the region or area of the signal modulating elements SME that falls within its boundaries shown in dashed outline and that is aligned with or overlaps the interior area INTA. DSME is the average dimension along the measuring axis direction MA of the effective region EffRSME of a signal modulating element SME. In various implementations, the average dimension DSME may be taken as the area of the effective region EffRSME of a signal modulating element SME divided by the y-axis direction dimension of that effective region EffRSME. For convenience and consistency of definition, for conductive plate type signal modulating elements SME the relevant dimensions may correspond to the edge of the SME, and for conductive loop type signal modulating elements SME the relevant dimensions may correspond to the conductors midline. For the implementations shown in FIGS. 5A and 5B the y-axis direction dimension of that effective region EffRSME is the same as the dimension YSEP, because the dimension YSEP of the interior area INTA of the field generating coil FGC is smaller than, and included within, the −y-axis dimension of the signal modulating elements SME. However, this need not be the case in all implementations (e.g., as shown in FIG. 7), and the previous definition of the effective region EffRSME is more general, including cases where the y-axis direction dimension of that effective region EffRSME is less than the dimension YSEP.

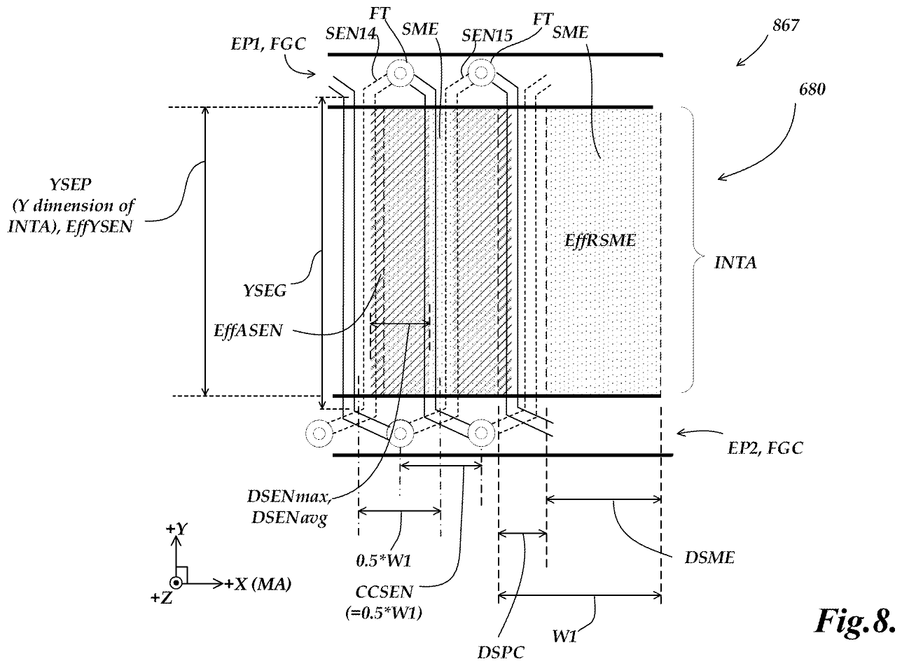

The previously outlined effective area EffASEN of the sensing elements SEN is indicated by slanted line fill within the area of a sensing element SEN that falls within its boundaries shown in solid outline and that is aligned with or overlaps the interior area INTA. As previously outlined, DSENmax is the maximum sensing element width dimension along the x-axis or measuring axis direction MA for the effective area EffASEN of the sensing element SEN. DSENavg is the average sensing element width dimension, defined as DSENavg=EffASEN/EffYSEN. As previously outlined, EffYSEN is the y-axis dimension of the sensing element effective area EffASEN. In the particular implementations shown in FIGS. 5A and 5B, the effective y-axis dimension EffYSEN is equal to YSEP, because each of the sensing elements SEN has a maximum sensing element dimension along the y-axis direction that exceeds YSEP and its effective area EffASEN therefore extends over the entire dimension YSEP. For the particular implementation shown in FIG. 5A, the effective area EffASEN has parallel sides that are perpendicular to the x-axis direction and have a dimension YSEG that spans YSEP, therefore DSENavg is the same as DSENmax. YSEG is defined for convenience as the y-direction of dimension of segments of the conductors that define sensing elements SEN that are located at the maximum dimension DSENmax apart from one another and that extend straight along the y-axis direction. For the particular implementation shown in FIG. 5B, the effective area EffASEN has a configuration that has the dimension DSENmax at its middle along the y-axis direction, but its sides taper or curve in such that it becomes narrower toward the top and bottom of its effective area EffASEN. Therefore, DSENavg is somewhat less than DSENmax, as shown. For convenience and consistency of definition, when determining DSENavg=EffASEN/EffYSEN a sensing element SEN the relevant dimensions may correspond the midline of its defining conductors. In the implementations shown in FIGS. 5A and 5B, DSENmax is nominally 0.5*W1. However, this value is not limiting (e.g., as shown below in FIG. 8.) The dimensions DSENavg of the configurations of sensing elements SEN shown in FIGS. 5A and 5B are not preferred according to principles outline below with reference to FIGS. 6, 7 and 8, and are presented only to clarify the definition or determination of DSENavg. The dimension CCSEN shown in FIG. 5B is the center-to-center spacing of the sensing elements SEN along the x-axis direction. In various embodiments, it may be advantageous if CCSEN is 0.5*W1, regardless of the shape or dimension DSENavg of the sensing elements SEN.

FIGS. 5A and 5B also illustrate a dimension DSPC, which is equal to W1 minus DSME. Described a first way, the dimension DSPC may be described as corresponding to “non-signal modulating space” between the signal modulating elements SME of the first type. However, more generally described a second way that applies to various other implementations of a periodic scale pattern, the dimension DSPC may be described as corresponding to signal modulating elements of a second type are located between the signal modulating elements SME of the first type along the measuring axis direction. The signal modulating elements of the second type are configured to have relatively less effect on the changing magnetic flux in comparison to the signal modulating elements SME of the first type. For example, in some implementations, the signal modulating elements of the second type comprise regions of non-conductive material. In some such implementations, the signal modulating elements of the second type comprise regions of a non-conductive scale substrate, wherein the first type of signal modulating elements SME comprise conductors fabricated and/or fixed on the non-conductive scale substrate. As another example, in some implementations, the signal modulating elements of the second type may comprise “more deeply recessed” regions of a conductive material used to form the scale pattern and the signal modulating elements SME of the first type may comprise “unrecessed” regions of the conductive material.

Returning now to the discussion of filtering the 3^{rd} spatial harmonic error component (which is periodic at 0.33*W1) from the sensing element signals, as previously noted the inventor has discovered certain configurations of the sensing elements SEN that may be used in combination with configurations of the signal modulating element SME outlined above to remedy the spatial filtering shortcomings outlined above. It has been known in the prior art to attempt to filter the 3^{rd} spatial harmonic error component from the sensing element signals by various means. One approach has been to configure the sensing elements in a sinusoidal shape which theoretically includes only the fundamental spatial frequency corresponding to W1. However, due to various practical considerations and/or fabrication limitations and/or assembly or gap variations, this has not completely suppressed the 3^{rd} spatial harmonic error component. Another approach has been to arrange sets of sensing elements SETSEN at spatial phases that are 0.33*W1 apart from one another, and process the resulting signals to remove the 3^{rd} spatial harmonic error component. This approach is relatively effective, but in many applications it is desirable for practical reasons to provide quadrature signals (that is, at spatial phases that are 0.25*W1 apart) from the sets of sensing elements SETSEN, which makes it impractical to arrange sets of sensing elements SETSEN at spatial phases that are 0.33*W1 apart.

To solve the problems and deficiencies inherent in the approached outlined above, the inventor has discovered that configurations of the sensing elements SEN that provide a sensing element average dimension DSENavg in a particularly advantageous range may be used in combination with configurations of the signal modulating element SME outlined above to substantially filter and/or suppress the 3^{rd} spatial harmonic error component. Surprisingly, the particularly advantageous range does not include 0.33*W1, which might be expected based on obvious theoretical considerations. Rather, as disclosed herein, it is particularly advantageous when a sensing element SEN are configured to provide an sensing element average dimension DSENavg that is at least 0.285*W1 and at most 0.315*W1 is used in combination with signal modulating elements SME that have an average dimension DSME that is at least 0.55*W1 and at most 0.8*W1, for a practical range of wavelengths W1 and operating gaps. Various desirable configurations for such sensing elements SEN are described in detail below with reference to FIGS. 6, 7, and 8.

FIG. 6 is a plan view diagram of illustrating certain aspects of a first exemplary implementation of sensing elements SEN and signal modulating elements SME configured and combined according to principles outlined above, for use in a detector portion 667 and scale pattern 680 in an electronic position encoder such as that shown in FIG. 1, along with of various dimensions that may characterize their features according to principles outlined above. It will be appreciated that certain numbered and/or named components may correspond to and/or operate similarly to similarly numbered or named components of FIGS. 5A and 5B, and may be similarly understood unless otherwise indicated. Therefore, only certain differences in the sensing elements SEN and signal modulating elements SME will be emphasized in the following description. The implementation shown in FIG. 6 includes a signal modulating elements SME analogous to those shown in FIGS. 5A and 5B, having an effective region EffRSME that has an average dimension DSME that is approximately 0.75*W1 (in this particular implementation.)

The sensing elements SEN include conductors on a first fabrication layer (shown in solid outline), and conductors on a second fabrication layer (shown in dashed outline) which are connected through feedthroughs FT according to known methods (e.g., as described in the incorporated references). The field generating coil FGC is fabricated on a third fabrication layer in this implementation to insulate it from the feedthroughs FT. As shown in FIG. 6, the conductors of a sensing element SEN include the y-axis direction segments that have the short y-axis dimension YSEG and that are spaced apart along the x-axis direction at DSENmax=0.5*W1, and segments that taper from the y-axis direction segments to the feedthroughs FT. The associated trapezoid shaped effective area EffASEN (indicated by slanted line fill in FIG. 6) has the y-axis dimension EffySEN which is equal to YSEP in this implementation. In various implementations, the sensing element SEN is configured such that DSENavg=EffASEN/EffYSEN is at least at least 0.285*W1 and at most 0.315*W1. In some implementations, it may be desirable if DSENavg is at least 0.29*W1 and at most 0.31*W1. For a given choice of DSENmax, various values of DESNavg may be provided by configuring the dimension YEG and the location of the feedthroughs and the adjoining conductors appropriately. In some such implementations, the y-axis dimension YSEG may be zero. Although DSENmax is nominally 0.5*W1 in the particular implementation that is illustrated, it is possible to configure the conductors of various layers to include overlapping x-axis direction segments in the vicinity of the dimension YSEG and between the adjacent sensing elements SEN, such that DSENmax may be less than 0.5*W1, if desired.

FIG. 7 is a plan view diagram of illustrating certain aspects of a second exemplary implementation of sensing elements SEN and signal modulating elements SME configured and combined according to principles outlined above, for use in a detector portion 767 and scale pattern 680 in an electronic position encoder such as that shown in FIG. 1, along with of various dimensions that may characterize their features according to principles outlined above. It will be appreciated that certain numbered and/or named components may correspond to and/or operate similarly to similarly numbered or named components of FIGS. 6 (and 5A and 5B), and may be similarly understood unless otherwise indicated. Therefore, only certain differences in the sensing elements SEN and signal modulating elements SME will be emphasized in the following description. The implementation shown in FIG. 7 includes a signal modulating elements SME analogous to those shown in FIG. 6, having an effective region EffRSME that has an average dimension DSME that is approximately 0.75*W1 (in this particular implementation.)

The sensing elements SEN are analogous to those shown in FIG. 6 and include conductors on a first fabrication layer (shown in solid outline), and conductors on a second fabrication layer (shown in dashed outline) which are connected through feedthroughs FT according to known methods (e.g., as described in the incorporated references). However, the feedthroughs FT are located within the interior area INTA. This has the advantage that the field generating coil FGC may be fabricated on the first and/or second fabrication layer in this implementation, which reduces the manufacturing cost of the detector portion 767. It has the disadvantage that the effective area EffASEN of the sensing elements SEN may be smaller than the implementation shown in FIG. 6, which may reduce the signal strength. However, this may be a desirable tradeoff in some applications. The effective area EffASEN in this implementation (indicated by slanted line fill in FIG. 7) has the y-axis dimension EffySEN which is less than YSEP in this implementation. In various implementations, the sensing element SEN is configured such that DSENavg=EffASEN/EffYSEN is at least 0.285*W1 and at most 0.315*W1. In some implementations, it may be desirable if DSENavg is at least 0.29*W1 and at most 0.31*W1. For a given choice of DSENmax, various values of DESNavg may be provided by configuring the dimension YEG and the location of the feedthroughs and the adjoining conductors appropriately. Although DSENmax is nominally 0.5*W1 in the particular implementation that is illustrated, it is possible to configure the conductors of various layers to include overlapping x-axis direction segments in the vicinity of the dimension YSEG and between the adjacent sensing elements SEN, such that DSENmax may be less than 0.5*W1, if desired. For similarly shaped implementations, when DSENmax is 0.5*W1 or less, the dimension YSEG may need to be at least 0.14*EffYSEN or more, in order that DESNavg is at least 0.285*W1.

FIG. 8 is a plan view diagram of illustrating certain aspects of a third exemplary implementation of sensing elements SEN and signal modulating elements SME configured and combined according to principles outlined above, for use in a detector portion 867 and scale pattern 680 in an electronic position encoder such as that shown in FIG. 1, along with of various dimensions that may characterize their features according to principles outlined above. It will be appreciated that certain numbered and/or named components may correspond to and/or operate similarly to similarly numbered or named components of FIGS. 6 (and 5A and 5B), and may be similarly understood unless otherwise indicated. Therefore, only certain differences in the sensing elements SEN and signal modulating elements SME will be emphasized in the following description. The implementation shown in FIG. 8 includes a signal modulating elements SME analogous to those shown in FIG. 6, having an effective region EffRSME that has an average dimension DSME that is approximately 0.75*W1 (in this particular implementation.)

The sensing elements SEN are analogous to those shown in FIG. 6 and include conductors on a first fabrication layer (shown in solid outline), and conductors on a second fabrication layer (shown in dashed outline) which are connected through feedthroughs FT according to known methods (e.g., as described in the incorporated references). The field generating coil FGC is fabricated on a third fabrication layer in this implementation to insulate it from the feedthroughs FT. As shown in FIG. 6, the conductors of a sensing element SEN include the y-axis direction segments that have the long y-axis dimension YSEG (longer than and spanning across the dimension YSEP of the interior area INTA) and that are spaced apart along the x-axis direction at DSENmax, and segments that join these segments to the feedthroughs FT. The associated rectangularly shaped effective area EffASEN (indicated by slanted line fill in FIG. 8) has the y-axis dimension EffySEN which is equal to YSEP in this implementation. In this implementation, DSENavg=DESNmax. In various implementations, the sensing element SEN is configured such that DSENmax and DSENavg are at least at least 0.285*W1 and at most 0.315*W1. In some implementations, it may be desirable if DSENmax and DSENavg are at least 0.29*W1 and at most 0.31*W1. The implementation shown in FIG. 8 may be less sensitive to signal changed that might otherwise arise due to various misalignment errors.

Regarding the advantageous range for the dimension DSME of the signal modulating element SME disclosed above, for many practical applications which use the largest practical gap allowed by signal strength considerations, the most advantageous value(s) for DSME may be at least 0.66*W1, or 0.7*W1, or more. For example, in various implementations, a value of 0.75*W1 for DSME has been verified to be particularly advantageous. However, as implied by previous discussion, this may depend to some extent on the particular wavelength W1, and the particular operating gap and operating frequency, and the particular shape and construction of the signal modulating element(s) SME.

Regarding the advantageous range for the dimension DSENavg of the sensing element SEN disclosed above, for many practical applications which use the largest practical gap allowed by signal strength considerations and the most advantageous value(s) for DSME outlined above (e.g., DSME=0.75*W1), the value of DSENavg that combines most advantageously may be within the range 0.29*W1 to 0.31*W1, and in some implementations DSENavg=0.30*W1 has been verified to be particularly advantageous. However, as implied by previous discussion, this depends to some extent on the particular wavelength W1, and the particular operating gap, and the particular dimension DSME, and shape and construction of the signal modulating element(s) SME.

It should be appreciated that the 3^{rd} spatial harmonic error content in the signal from a set of signal modulating elements SETSEN is extremely sensitive to the selection of dimensions within the ranges disclosed above. For example, it is desirable that the dimension DESNavg be selected such that it rejects the 3^{rd} spatial harmonic error content in a signal for practical variations in the fabricated dimensions and/or variations in the operating gap associated with a set of signal modulating elements SETSEN. Surprisingly, the inventor has discovered that in one implementation configured to provide a value of 0.3*W1 for DSENavg, error components associated with the 3^{rd} spatial harmonic error content are uniformly insensitive to variations of the dimension DSME of the signal modulating elements SEN of over a range DSME=0.72*W1 to DSME=0.79*W1. In contrast, if the value DSENavg is changed by as little as 10% from this value (e.g., to 0.27*W1 or 0.33*W1) then error components associated with the 3^{rd} spatial harmonic error content increase unacceptably by a factor of 10 or more for variations in the sensing elements SEN of over the range of DSME=0.72*W1 to DSME=0.79*W1.

Regarding why the advantageous range for the dimension DSENavg disclosed is significantly different than the “naively” expected value of 0.33*, one possible explanation that error components arising from scale-position-dependent impedance variations in the detector are influenced by DSENavg. Such position-dependent impedance variations may be on the order of 1%, and have been unknown or not considered in the prior art. It may be possible that the advantageous range for DSENavg disclosed herein “adjusts” or tunes these impedance variations such that when their signal component contributions are “aliased” to combine with other sources of 3^{rd} spatial harmonic error content, the sum of the effects is to negate the 3^{rd} spatial harmonic error content. Such subtle effects and associated design characteristics have not been considered in the prior art.

While preferred implementations of the present disclosure have been illustrated and described, numerous variations in the illustrated and described arrangements of features and sequences of operations will be apparent to one skilled in the art based on this disclosure. Various alternative forms may be used to implement the principles disclosed herein.

It will be appreciated that the principles disclosed and claimed herein may be readily and desirably combined with various features disclosed in the incorporated references, as well as with various features disclosed in copending U.S. patent application Ser. No. 16/826,842 which is hereby incorporated by reference in its entirety. The various implementations described above can be combined to provide further implementations. All of the U.S. patents and U.S. patent applications referred to in this specification are incorporated herein by reference, in their entirety. Aspects of the implementations can be modified, if necessary to employ concepts of the various patents and applications to provide yet further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled.

What is claimed is:

1. An electronic position encoder usable to measure a relative position between two elements along a measuring axis direction, the electronic position encoder comprising:
a scale extending along the measuring axis direction which includes a periodic scale pattern comprising at least a first type of signal modulating elements, wherein the periodic scale pattern has a spatial wavelength W1 and signal modulating elements of the first type comprising similar conductive plates or similar conductive loops that are located along the measuring axis direction corresponding to the spatial wavelength W1;
a detector portion configured to be mounted proximate to the periodic scale pattern and to move along the measuring axis direction relative to the periodic scale pattern, the detector portion comprising:
a field generating coil fixed on a substrate, the field generating coil surrounding an interior area that is aligned with periodic scale pattern of signal modulating elements during operation, the field generating coil generating a changing magnetic flux in the interior area in response to a coil drive signal; and
a set of sensing elements arranged along the measuring axis direction and fixed on the substrate, members of the set of sensing elements comprising conductive loops or conductive loop portions that define a sensing element effective area EffASEN corresponding to that portion of the sensing element that is aligned with or overlaps the interior area, wherein the set of sensing elements are configured to provide detector signals which respond to a local effect on the changing magnetic flux provided by adjacent signal modulating elements of the scale pattern; and
a signal processing configuration that is operably connected to the detector portion to provide the coil drive signal and that determines a relative position between the detector portion and the scale pattern based on detector signals input from the detector portion,
wherein:
the signal modulating elements of the first type include an effective region EffRSME that is aligned with or overlaps the interior area during operation, and the effective region has an average dimension DSME along the measuring axis direction that is at least 0.55*W1 and at most 0.8*W1; and
the sensing element effective area EffASEN that is aligned with or overlaps the interior area has an effective y-axis dimension EffYSEN along a y-axis direction that is perpendicular to the measuring axis direction, and a maximum dimension DSENmax along the measuring axis direction, and is configured to provide a sensing element average dimension DSENavg=(EffASEN/EffYSEN) along the measuring axis direction that is at least 0.285*W1 and at most 0.315*W1.

2. The electronic position encoder of claim 1, wherein DSENavg is at least 0.29*W1 and at most 0.31*W1.

3. The electronic position encoder of claim 1, wherein DSENmax is least 0.285*W1 and at most 0.5*W1.

4. The electronic position encoder of claim 3, wherein the conductive loops or conductive loop portions that define the effective area EffASEN comprise y-direction segments that are located at the maximum dimension DSENmax apart from one another and that extend straight along the y-axis direction and have a y-axis dimension YSEG that is at least 0.14*EffYSEN.

5. The electronic position encoder of claim 4, wherein DSENmax is nominally 0.5*W1.

6. The electronic position encoder of claim 4, wherein the y-direction segment dimension YSEG spans the entire interior area along the −y-axis direction and the y-direction segments are spaced apart from one another along the measuring axis direction at the maximum dimension DSENmax, wherein DSENavg=DSENmax, and DSENMax is at least 0.285*W1 and at most 0.315*W1.

7. The electronic position encoder of claim 1, wherein the average dimension DSME is at least 0.66*W1.

8. The electronic position encoder of claim 7, wherein the average dimension DSME is at least 0.7*W1.

9. The electronic position encoder of claim 1, wherein the signal modulating elements of the first type comprise the similar conductive plates.

10. The electronic position encoder of claim 1, wherein the signal modulating elements of the first type comprise the similar conductive loops.

11. The electronic position encoder of claim 1, wherein the detector portion and the scale include approximately planar substrates and the detector portion is configured to be mounted approximately parallel to the periodic scale pattern with a nominal operating gap between their respective conductors which is at least 0.075*W1.

12. The electronic position encoder of claim 11, wherein the nominal operating gap is at least 0.15*W1.

13. The electronic position encoder of claim 1, wherein W1 is at most 2 millimeters.

14. The electronic position encoder of claim 1, wherein W1 is at most 1.5 millimeters.
